(19) United States
(12) Patent Application Publication
(10) Pub. No.: US 2021/0339419 A1
(43) Pub. Date: Nov. 4, 2021

(54) PROCESSING DEVICE AND HOLDING MEMBER

(71) Applicant: BROTHER KOGYO KABUSHIKI KAISHA, Nagoya-shi (JP)

(72) Inventors: Hiroki MORI, Toyota-shi (JP); Daisuke ABE, Nagoya-shi (JP)

(21) Appl. No.: 17/378,115

(22) Filed: Jul. 16, 2021

Related U.S. Application Data
(63) Continuation of application No. PCT/JP2019/012756, filed on Mar. 26, 2019.

(30) Foreign Application Priority Data
Jan. 16, 2019 (JP) 2019-005233

(51) Int. Cl. B26D 5/34; B26D 7/02; B26D 7/26; B26F 1/24

(52) U.S. Cl. CPC B26D 5/34; B26F 1/24; B26D 7/26; B26D 7/02

(57) ABSTRACT

A processing device includes a mounting portion, a holding member configured to hold the target object, a first mover configured to move a mounting portion, a second mover configured to move the mounting portion and the holding member, a processor, and a memory. The processing device performs processing on a target object by penetrating the target object using a processing tool mounted to the mounting portion. The processor acquires processing data representing control conditions of the first mover and the second mover for causing the processing tool to penetrate the target object and perform processing on the target object. The processor controls the first mover and the second mover, on the basis of the acquired processing data, in a state in which the target object is held by the first holder, to cause the processing tool to penetrate the target object and perform the processing on the target object.

### CROSS-REFERENCE TO RELATED APPLICATION

This application is a Continuation Application of International Application No. PCT/JP2019/012756, filed Mar. 26, 2019, which claims priority from Japanese Patent Application No. 2019-005233, filed on Jan. 16, 2019. Both of the applications are incorporated herein by reference in their entireties.

### BACKGROUND

The present disclosure relates to a processing device capable of processing a target object in accordance with processing data, and a holding member used in the processing device.

A plotter for cutting a sheet-like target object is known. The plotter includes a carriage holding a cutter. The plotter cuts the target object by causing a sheet holder holding the target object and the carriage to move relative to each other.

### SUMMARY

In order to cut the target object, the plotter moves the cutter downward until the leading edge of the cutter pierces the target object and reaches the sheet holder below the target object. In this case, a plurality of recesses are formed in the sheet holder as a result of being pierced by the cutter. There is a possibility that the plurality of recesses may cause a holding capability of the target object by the sheet holder to deteriorate. When the holding capability deteriorates, there is a problem that the target object becomes displaced from the sheet holder during cutting processing, and the cutting processing by the plotter cannot be appropriately performed. This problem also occurs when, in place of the cutter, processing to create decorations by moving a needle repeatedly in the up-down direction to form a plurality of through holes (hereinafter referred to simply as “holes”) in the target object (hereinafter referred to as “perforating”) is performed.

The object of the present disclosure is to provide a processing device and a holding member capable of appropriately performing processing while maintaining a holding capability of a target object on a holding portion.

Various embodiments herein provide a processing device that performs processing on a target object by penetrating the target object using a processing tool. The processing device includes a mounting portion, a holding member, a first mover, a second mover, a processor, and a memory. The processing tool is mountable to the mounting portion. The holding member includes at least a first holder. The first holder has a plate shape and is configured by an elastomer gel having self-adhesive properties. The holding member is able to hold the target object at a first surface of the first holder. The first mover is configured to move a mounting portion, to which the processing tool is mounted, in a first direction. The first mover moves the processing tool in a direction toward the holding member when the mounting portion has moved to one side in the first direction. The first mover moves the processing tool in a direction separating from the holding member when the mounting portion has moved to another side in the first direction. The second mover is configured to move the mounting portion and the holding member relative to each other, in a second direction and a third direction orthogonal to the first direction and orthogonal to each other. The processor is configured to control the first mover and the second mover and move the mounting portion and the holding member relative to each other. The memory is configured to store computer-readable instructions that, when executed by the processor, instruct the processor to perform processes. The processes include acquiring processing data representing control conditions of the first mover and the second mover for causing the processing tool to penetrate the target object and perform processing on the target object, and controlling the first mover and the second mover, on the basis of the acquired processing data, in a state in which the target object is held by the first holder, to cause the processing tool to penetrate the target object and perform the processing on the target object.

Various embodiments herein also provide a holding member used in a processing device that performs processing on a target object by causing a processing tool to penetrate the target object. The holding member includes a first holder and a second holder. The first holder is a plate shape and is configured by a urethane elastomer gel having self-adhesive properties, and is configured to be able to hold the target object at a first surface of the first holder. The second holder has a surface area larger than that of the first holder, and is configured to hold the first holder by coming into contact with a second surface that is a surface on the opposite side from the first surface of the first holder. The first holder is removably held by the second holder. The Asker C hardness of the first holder is from 20 to 40. An adhesive force of the first holder is from 0.5 N/25 mm to 6.0 N/25 mm when at 20° C.

Various embodiments herein also provide a holding member used in a processing device that performs processing on a target object by causing a processing tool to penetrate the target object. The holding member includes a first holder and a second holder. The first holder is a plate shape and is configured by a urethane elastomer gel having self-adhesive properties, and configured to be able to hold the target object at a first surface of the first holder. The second holder has a surface area larger than that of the first holder, and is configured to be adhered to a second surface that is a surface on the opposite side from the first surface of the first holder. The first holder is adhered to the second holder at a region excluding a peripheral edge portion of the second holder. The Asker C hardness of the first holder is from 20 to 40. An adhesive force of the first holder is from 0.5 N/25 mm to 6.0 N/25 mm when at 20° C. The second holder includes a mark, on the peripheral edge portion, indicating the holding member including the first holder.

### BRIEF DESCRIPTION OF THE DRAWINGS

Embodiments of the disclosure will be described below in detail with reference to the accompanying drawings in which:

FIG. 1 is a perspective view of a cutting device 1A;

FIG. 2 is a plan view of a mounting portion 32 and an up-down drive mechanism 33;

FIG. 3 is a perspective view of the mounting portion 32 and the up-down drive mechanism 33 when cut along a line B-B shown in FIG. 2;

FIG. 4 is a cross-sectional view of a first holding member 101 when cut along a line A-A shown in FIG. 1;

FIG. 5 is a front view of a needle module P;

FIG. 6 is a block diagram showing an electrical configuration of the cutting device 1A;

FIG. 7 is a flowchart of main processing;

FIG. 8 is explanatory diagrams for explaining a method for determining whether or not the first holding member 101 is held by a second holding member 102;

FIG. 9 is explanatory diagram showing processing positions;

FIG. 10 is a table showing a relationship between a hardness and adhesive properties of a urethane gel mat 10B at a time of a cutting operation;

FIG. 11 is a table showing a relationship between the hardness and the adhesive properties of the urethane gel mat 10B at a time of a perforating operation;

FIG. 12 is a table showing a relationship between an adhesive force and the adhesive properties of the urethane gel mat 10B at the time of the cutting operation;

FIG. 13 is a table showing a relationship between the adhesive force and the adhesive properties of the urethane gel mat 10B at the time of the perforating operation;

FIG. 14 is a cross-sectional view of an integrated holding member 10G according to a modified example; and

FIG. 15 is a plan view of the integrated holding member 10G according to the modified example.

### DETAILED DESCRIPTION OF EMBODIMENTS

Embodiments embodying the present disclosure will be described in order with reference to the drawings. The drawings to be referenced are used to illustrate the technical features that can be adopted in the present disclosure, and the described structures and the like of the devices are not intended to be limited thereto, but are merely explanatory examples.

Overview of cutting device 1A

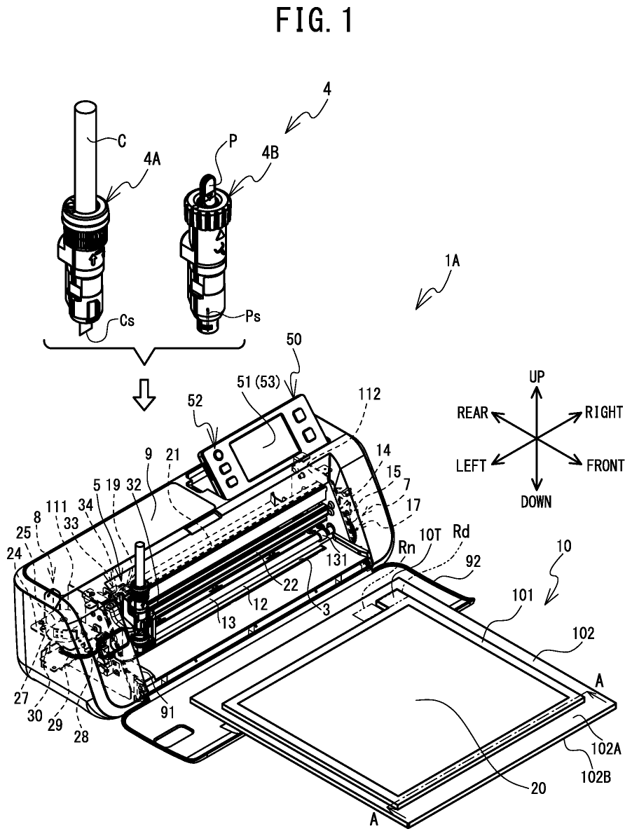

An overview of a cutting device 1A will be described with reference to FIG. 1 to FIG. 3. The cutting device 1A is used in a state fitted with a cartridge 4A capable of fixing a cutting module C, or a cartridge 4B capable of fixing a needle module P. When the cutting device 1A is fitted with the cartridge 4A, the cutting device 1A can cut a sheet-like target object 20 using a cutting blade Cs of the cutting module C. Further, when the cutting device 1A is fitted with the cartridge 4B, the cutting device 1A can perform perforating, by causing a needle Ps of the needle module P to pierce the target object 20 and form a plurality of holes. The cartridges 4A and 4B are collectively referred to as a “cartridge 4.” The lower left side, the upper right side, the lower right side, the upper left side, the upper side, and the lower side in FIG. 1 are the left side, the right side, the front side, the rear side, the upper side, and the lower side, respectively, of the cutting device 1A and the cartridge 4.

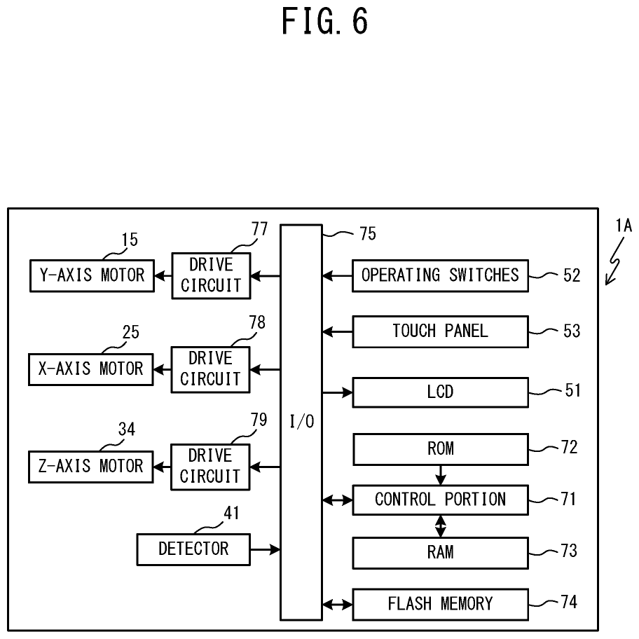

The cutting device 1A is provided with a main body cover 9, a platen 3, a head 5, a conveyance portion 7, a movement portion 8, a holding member 10, and a control portion 71 (refer to FIG. 6). The holding member 10 is conveyed in the front-rear direction by the cutting device 1A, in a posture in which the lengthwise direction of the holding member 10 is the front-rear direction. The holding member 10 has a rectangular shape, and the target object 20 is held on the upper surface of the holding member 10. The main body cover 9 is provided with an opening 91, a cover 92, and an operating portion 50. The opening 91 is an opening provided in a front surface portion of the main body cover 9. The cover 92 is a plate-shaped member that is long in the left-right direction. A lower end side of the cover 92 is supported by the main body cover 9 so as to be able to rotate. In FIG. 1, the cover 92 is open such that the opening 91 is open.

The operating portion 50 is provided with a liquid crystal display (LCD) 51, a plurality of operating switches 52, and a touch panel 53. An image including various items, such as commands, illustrations, setting values, and messages is displayed on the LCD 51. The touch panel 53 is provided on the surface of the LCD 51. A user performs a pressing operation (hereinafter, this operation is referred to as a “panel operation”) on the touch panel 53, using either a finger or a stylus pen. In the cutting device 1A, which of the items has been selected is recognized in accordance with a pressed position detected by the touch panel 53. The user can use the operating switches 52 and the touch panel 53 to select a pattern displayed on the LCD 51, set various parameters, perform an input operation, and the like.

The platen 3 is provided inside the main body cover 9. The platen 3 is a plate-shaped member that extends in the left-right direction. The platen 3 receives the lower surface of the holding member 10, and the holding member 10 for holding the target object 20 can be placed on the platen 3. The holding member 10 is set on the platen 3 while the opening 91 is open.

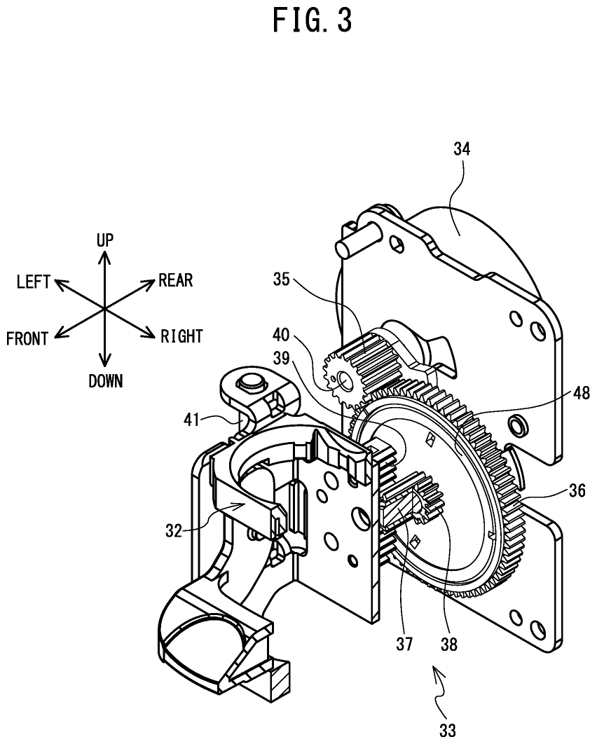

The head 5 is provided with a carriage 19, a mounting portion 32, a detector 41 (refer to FIG. 3), and an up-down drive mechanism 33. The mounting portion 32 and the up-down drive mechanism 33 are disposed to the front and rear of the carriage 19, respectively. The mounting portion 32 is able to be fitted with the cartridge 4. When the cartridge 4A is fitted in a state in which the cutting module C is fixed thereto, the cartridge 4A is fixed to the mounting portion 32 in a state in which the cutting blade Cs is arranged on the lower end of the cartridge 4A. When the cartridge 4B is fitted in a state in which the needle module P is fixed thereto, the cartridge 4B is fixed to the mounting portion 32 in a state in which the needle Ps is arranged on the lower end of the cartridge 4B.

The up-down drive mechanism 33 moves the mounting portion 32 in a direction in which the mounting portion 32 moves toward the holding member 10 (i.e. downward), and a direction in which the mounting portion 32 moves away from the holding member 10 (i.e. upward). In this way, the up-down drive mechanism 33 moves the cartridge 4 mounted to the mounting portion 32 in the up-down direction. The up-down drive mechanism 33 of a present example is provided with a Z-axis motor 34 and a transmission member. The up-down drive mechanism 33 uses the transmission member coupled to an output shaft of the Z-axis motor 34 to decelerate and convert a rotational movement of the Z-axis motor 34 into an up-down movement, transmits the up-down movement to the mounting portion 32, and drives the mounting portion 32 and the cartridge 4 in the up-down direction (also referred to as a Z direction). In other words, the Z-axis motor 34 drives the mounting portion 32 and the cartridge 4 in the up-down direction.

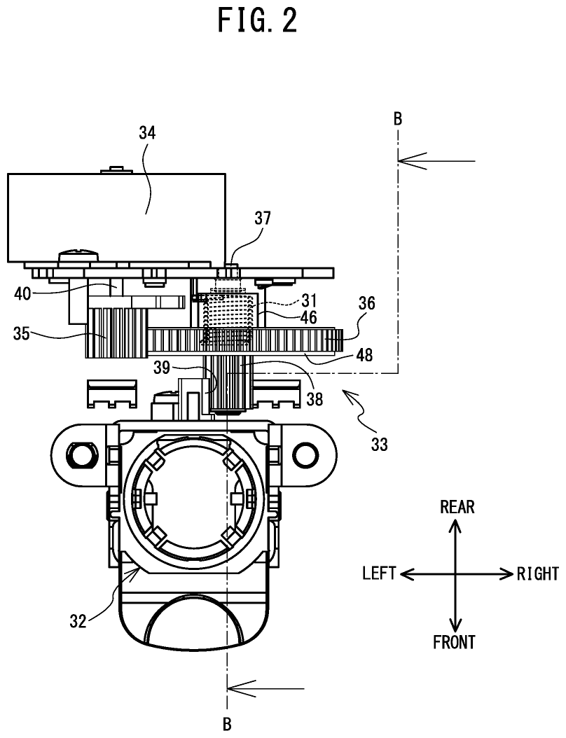

As shown in FIG. 2 and FIG. 3, the up-down drive mechanism 33 includes, as transmission members, gears 35 and 36, a shaft 37, a plate portion 48, a pinion 38, and a rack 39. The gear 35 is fixed to a front end of an output shaft 40 of the Z-axis motor 34. The gear 35 meshes with the gear 36. A diameter of the gear 35 is smaller than a diameter of the gear 36. The gear 36 includes a cylindrical shaft portion 46 that extends in the front-rear direction. The shaft 37 is inserted through the shaft portion 46 of the gear 36. The output shaft 40 of the Z-axis motor 34 and the shaft 37 extend in the front-rear direction. The plate portion 48 is a disc-shaped plate that is slightly smaller than the diameter of the gear 36. A front end portion of the plate portion 48 is coupled to a rear end portion of the pinion 38. The plate portion 48 is a member that is integrated with the pinion 38. The plate portion 48 is a member that is separate from the gear 36. The plate portion 48 and the pinion 38 can rotate independently of the rotation of the gear 36. The shaft 37 is inserted through the pinion 38 and the plate portion 48, to the front of the gear 36. The pinion 38 and the plate portion 48 can rotate relative to the shaft 37. The diameter of the pinion 38 is smaller than the diameters of the gears 35 and 36. The rack 39 extends in the up-down direction, and gear teeth with which the pinion 38 meshes are provided on the right surface of the rack 39. The rack 39 is fixed to the rear surface of the mounting portion 32.

The up-down drive mechanism 33 is further provided with a pressure changing member 31. The pressure changing member 31 is a torsion spring that is inserted through the shaft portion 46 of the gear 36. The pressure changing member 31 is a member that can change a downward pressure applied to the mounting portion 32. One end of the pressure changing member 31 is fixed to the shaft portion 46, and the other end is fixed to the plate portion 48. The pressure changing member 31 transmits the rotation of the gear 36 to the plate portion 48. The pressure changing member 31 changes the downward pressure applied to the mounting portion 32, by changing a compression amount of the torsion spring in accordance with the rotation of the gear 36.

The detector 41 is a position sensor that can output a position, in the up-down direction, of the mounting portion 32. The detector 41 is disposed to the left and rear of the mounting portion 32. The detector 41 can identify the position of the mounting portion 32 in the up-down direction, and can output a signal indicating the identified position.

The conveyance portion 7 conveys the target object 20 held by the holding member 10 in a sub-scanning direction orthogonal to a main scanning direction by conveying a second holding member 102 of the holding member 10 in the sub-scanning direction. The main scanning direction and the sub-scanning direction in this example are the left-right direction and the front-rear direction, respectively. The conveyance portion 7 is configured to be able to convey the holding member 10 set on the platen 3 in the front-rear direction (also referred to as a Y direction) of the cutting device 1A. The conveyance portion 7 conveys the target object 20 held by the holding member 10 in the sub-scanning direction. The conveyance portion 7 is provided with a driving roller 12, a pinch roller 13, an attachment frame 14, a Y-axis motor 15, and a deceleration mechanism 17. A pair of side wall portions 111 and 112 are provided facing each other, inside the main body cover 9. The side wall portion 111 is positioned to the left of the platen 3. The side wall portion 112 is positioned to the right of the platen 3. The driving roller 12 and the pinch roller 13 are rotatably supported between the side wall portions 111 and 112. The driving roller 12 and the pinch roller 13 transport the holding member 10. The driving roller 12 and the pinch roller 13 extend in the left-right direction (also referred to as an X direction) of the cutting device 1A, and are aligned in the up-down direction. A roller portion (not shown in the drawings) is provided on the left end of the pinch roller 13, and a roller portion 131 is provided on the right end of the pinch roller 13.

The attachment frame 14 is fixed to the outer surface side (the right side) of the side wall portion 112. The Y-axis motor 15 is attached to the attachment frame 14. An output shaft of the Y-axis motor 15 is fixed to a driving gear (not shown in the drawings) of the deceleration mechanism 17. The driving gear meshes with a driven gear (not shown in the drawings). The driven gear is anchored to a leading end of a right end portion of the driving roller 12.

When the holding member 10 is conveyed, the outer left portion of the holding member 10 is sandwiched between the driving roller 12 and the left roller portion (not shown in the drawings) of the pinch roller 13. The outer right portion of the holding member 10 is sandwiched between the driving roller 12 and the roller portion 131. When the Y-axis motor 15 is driven forward or in reverse, the rotational movement of the Y-axis motor 15 is transmitted to the driving roller 12 via the deceleration mechanism 17. That is, the Y-axis motor 15 drives the driving roller 12. As a result, the holding member 10 is conveyed forward or rearward.

The movement portion 8 is configured to be able to move the head 5 in a direction orthogonal to the conveyance direction of the holding member 10, i.e., in the X direction. That is, the movement direction of the head 5 is orthogonal to the conveyance direction of the holding member 10. The movement portion 8 is provided with a pair of upper and lower guide rails 21 and 22, an attachment frame 24, an X-axis motor 25, a driving gear 27 and a driven gear 29 as a deceleration mechanism, a transmission mechanism 30, and the like. The guide rails 21 and 22 are fixed between the side wall portions 111 and 112. The guide rails 21 and 22 are positioned to the rear of, and above, the pinch roller 13. The guide rails 21 and 22 extend substantially parallel to the pinch roller 13, i.e., in the X direction. The carriage 19 of the head 5 is supported by the guide rails 21 and 22 so as to be able to move in the X direction along the guide rails 21 and 22.

The attachment frame 24 is fixed to the outer surface side (the left side) of the side wall portion 111. The X-axis motor 25 is attached so as to be oriented downward, to the rear of the attachment frame 24. The driving gear 27 is fixed to an output shaft of the X-axis motor 25. The driven gear 29 meshes with the driving gear 27. Although not shown in the drawings, the transmission mechanism 30 includes a left and right pair of timing pulleys, and an endless timing belt that is stretched over the left and right pair of timing pulleys. A timing pulley 28 that is one of the timing pulleys is provided on the attachment frame 24, such that the timing pulley 28 can rotate integrally with the driven gear 29. The other timing pulley is provided on the attachment frame 14. The timing belts extend in the X direction and are coupled to the carriage 19.

The movement portion 8 moves the cartridge 4 mounted to the mounting portion 32 of the head 5 in the main scanning direction. The movement portion 8 converts the rotational movement of the X-axis motor 25 into motion in the X direction, and transmits this motion to the carriage 19. When the X-axis motor 25 is driven forward or in reverse, the rotational movement of the X-axis motor 25 is transmitted to the timing belt via the driving gear 27, the driven gear 29, and the timing pulley 28. In this way, the carriage 19 is moved to the left or to the right. In other words, the conveyance portion 7 and the movement portion 8 move the mounting portion 32 in the front-rear direction (the sub-scanning direction) and the left-right direction (the main scanning direction) with respect to the holding member 10.

Holding member 10

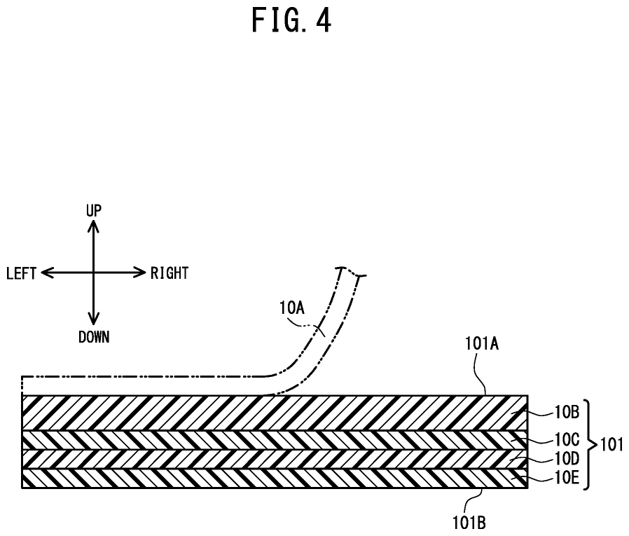

The holding member 10 will be explained with reference to FIG. 1 and FIG. 4. As shown in FIG. 1, the holding member 10 includes a first holding portion 101 and a second holding portion 102. Each of the first holding portion 101 and the second holding portion 102 has a plate shape.

The first holding portion 101 has a substantially rectangular shape, and is orthogonal to the up-down direction. A protrusion 10T that protrudes toward the rear is provided on the rear right end portion of the first holding portion 101. As shown in FIG. 4, the first holding portion 101 has a cross-sectional structure in which a urethane gel mat 10B, a base film 10C, an adhesive layer 10D, and a non-adhesive film 10E are layered in order from the top.

The base film 10C has a film shape, and is a base of the first holding portion 101. The base film 10C is formed of polyethylene terephthalate (PET). Note that the material of the base film 10C is not limited to PET, and may be formed of another material (polyvinyl chloride, polypropylene, or the like, for example). The urethane gel mat 10B is formed on the upper surface of the base film 10C. The urethane gel mat 10B is configured by an elastomer gel having self-adhesive properties, more specifically, by a urethane elastomer gel. The thickness of the urethane gel mat 10B is approximately 1 mm. The Asker C hardness of the urethane gel mat 10B is from 20 to 40, and is, more preferably, from 25 to 35. An adhesive force of the urethane gel mat 10B is from 0.5 N/25 mm to 6.0 N/25 mm at 20 degrees, and is, more preferably, from 1.5 N/25 mm to 4.0 N/25 mm at 20 degrees. The upper surface of the urethane gel mat 10B corresponds to the upper surface of the first holding portion 101. Hereinafter, this surface is referred to as a “first surface 101A.” By adhering the target object 20 to the first surface 101A using the self-adhesive properties of the urethane gel mat 10B, the first holding portion 101 can hold the target object 20 on the first surface 101A.

The non-adhesive film 10E is disposed on the lower surface of the base film 10C. The non-adhesive film 10E is formed of PET. The non-adhesive film 10E has nonadherent properties, and is not easily adhered to other films and the like. Thus, the upper surface of the non-adhesive film 10E is adhered to the lower surface of the base film 10C by an adhesive of the adhesive layer 10D. The lower surface of the non-adhesive film 10E corresponds to a surface that is opposite from the lower surface of the first holding portion 101, that is, the first surface 101A of the first holding portion 101. Hereinafter, this surface is referred to as a “second surface 101B.” Since the non-adhesive film 10E is exposed, the second surface 101B has nonadherent properties.

A cover film 10A may be adhered to the first surface 101A of the first holding portion 101. The cover film 10A has a film shape. When the first holding portion 101 has not yet been used, the cover film 10A prevents other substances from being adhered to the urethane gel mat 10B. The cover film 10A can be peeled from the urethane gel mat 10B. When the first holding portion 101 is used, the cover film 10A is removed from the first surface 101A to be used. In a state in which the cover film 10A has been removed from the first surface 101A, the urethane gel mat 10B is exposed. In this state, the first holding portion 101 can adhere the target object 20 to the first surface 101A and hold the target object 20.

As shown in FIG. 1, the second holding portion 102 has a rectangular shape, and is orthogonal to the up-down direction. The second holding portion 102 is formed of a synthetic resin, for example. The hardness of the second holding portion 102 is greater than the hardness of the urethane gel mat 10B of the first holding portion 101. The lengths in the front-rear direction and the left-right direction of the second holding portion 102 are longer, respectively, than the lengths of the first holding portion 101 in the front-rear direction and the left-right direction. When the holding member 10 is viewed from above, peripheral end portions of the first holding portion 101 are positioned further to the inner side than peripheral end portions of the second holding portion 102. The first holding portion 101 is surrounded by the peripheral end portions of the second holding portion 102. Thus, the surface area of the second holding portion 102 is larger than that of the first holding portion 101. The upper surface of the second holding portion 102 is referred to as a “third surface 102A”, and the lower surface of the second holding portion 102 is referred to as a “fourth surface 102B.”

Of the third surface 102A of the second holding portion 102, a region excluding the peripheral end portions (hereinafter referred to as an “adhesive region”) has adhesive properties. The second holding portion 102 can hold the first holding portion 101 using the third surface 102A, by the second surface 101B (refer to FIG. 4) of the first holding portion 101 being brought into contact with and adhered to the adhesive region of the third surface 102A. By conveying the second holding portion 102 in the state of holding the first holding portion 101, the conveyance portion 7 moves the mounting portion 32 and the first holding portion 101 relative to each other in the front-rear direction. In this way, the conveyance portion 7 can move the target object 20 held on the first surface 101A of the first holding portion 101 and the mounting portion 32 relative to each other in the front-rear direction.

Further, the first holding portion 101 can be removed from the second holding portion 102 by peeling the first holding portion 101 from the adhesive region of the third surface 102A. Furthermore, the second holding portion 102 can directly hold the target object 20 using the third surface 102A, by adhering the target object 20 to the adhesive region of the third surface 102A in a state in which the first holding portion 101 has been removed. By conveying the second holding portion 102 in the state of directly holding the target object 20, the conveyance portion 7 can move the target object 20 and the mounting portion 32 relative to each other in the front-rear direction.

As shown in FIG. 1, detection regions Rd and Rn of the holding member 10 are defined. When the first holding portion 101 is held by the second holding portion 102, the detection region Rd is a region in which the protrusion 10T of the first holding portion 101 and the second holding portion 102 are overlaid on each other. Note that, when the first holding portion 101 has been peeled off from the second holding portion 102, the protrusion 10T of the first holding portion 101 is not disposed in the detection region Rd and only the second holding portion 102 is disposed in the detection region Rd. The detection region Rn is positioned to the left of the detection region Rd. Irrespective of whether the first holding portion 101 is held by the second holding portion 102 or not, only the second holding portion 102 is always disposed in the detection region Rn.

Needle module P

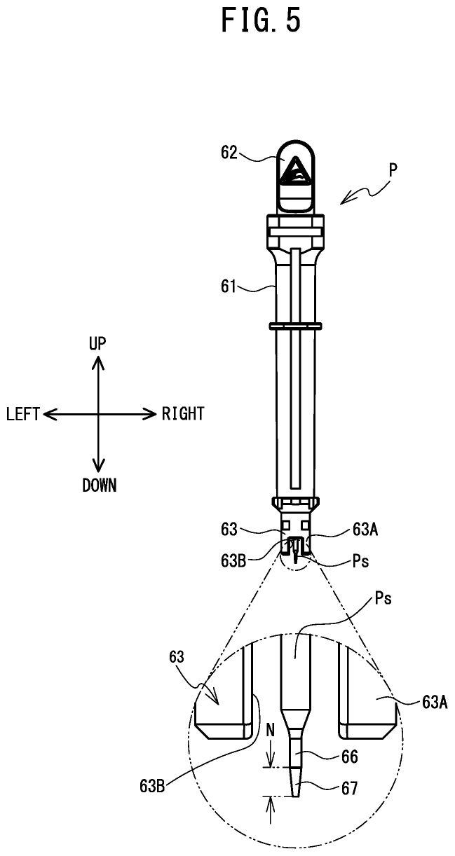

The needle module P is mounted to the cartridge 4B (refer to FIG. 1) and used. As shown in FIG. 5, the needle module P includes a base portion 61, a knob 62, a cover 63, and the needle Ps. The base portion 61 has a substantially cylindrical shape, and extends in the up-down direction. The knob 62 has a plate shape, and is provided on the upper end of the base portion 61. The knob 62 is gripped by the user when the needle module P is attached to or removed from the cartridge 4B. The cover 63 is provided on the lower end of the base portion 61. The cover 63 is configured by a cylindrical body 63A and a cut-out 63B. The cylindrical body 63A extends downward from the lower end of the base portion 61. The cut-out 63B is provided in the lower surface of the cylindrical body 63A. The cut-out 63B is a recess that is recessed upward. The cut-out 63B extends in the front-rear direction at the lower end of the cylindrical body 63A, from the front end to the rear end.

The needle Ps is held inside the base portion 61. An axial line of the needle Ps extends in the up-down direction. The tip end portion of the needle Ps protrudes downward from the bottom surface of the cut-out 63B of the cover 63. A section of the needle Ps that protrudes from the bottom surface of the cut-out 63B includes a first portion 66 and a second portion 67. The diameter of the first portion 66 is the same in the axial direction, and is approximately 0.4 mm to 0.8 mm. The second portion 67 is positioned further to a tip end side than the first portion 66. The diameter of the second portion 67 gradually decreases toward the tip end thereof in the axial direction. A length N in the axial direction of the second portion 67 is approximately 1 mm. The tip end of the needle Ps protrudes further downward than the lower end of the cylindrical body 63A of the cover 63.

Note that, since the thickness of the urethane gel mat 10B of the first holding portion 101 is 1 mm, as described above, the overall thickness of the first holding portion 101 becomes larger than 1 mm. Thus, the thickness of the first holding portion 101 (>1 mm) is greater than the length N (1 mm) of the second portion 67 in the axial direction.

Electrical configuration of cutting device 1A

An electrical configuration of the cutting device 1A will be explained with reference to FIG. 6. The cutting device 1A is provided with the control portion 71, a ROM 72, a RAM 73, and an input/output (I/O) interface 75. The control portion 71 is electrically connected to the ROM 72, the RAM 73, and the I/O interface 75. The control portion 71 is a CPU that performs overall control of the cutting device 1A, along with the ROM 72 and the RAM 73. The ROM 72 stores various programs used to operate the cutting device 1A. The RAM 73 temporarily stores arithmetic calculation results and the like calculated by the control portion 71.

Further, a flash memory 74, the operating switches 52, the touch panel 53, the LCD 51, the detector 41, and drive circuits 77 to 79 are connected to the I/O interface 75. The flash memory 74 is anon-volatile storage element that stores various parameters, cutting data, plot data, and the like.

The cutting data represents control conditions of the up-down drive mechanism 33, the conveyance portion 7, and the movement portion 8 for cutting the target object 20 using the cutting blade Cs and cutting out a desired shape. The cutting data includes start coordinates and end coordinates for controlling the conveyance portion 7 and the movement portion 8. The plot data represents control conditions of the up-down drive mechanism 33, the conveyance portion 7, and the movement portion when performing the perforating by forming the holes in the target object 20 using the needle Ps. The plot data include a plurality of plot coordinates for controlling the conveyance portion 7 and the movement portion 8. An origin point of the coordinate system is a point to the rear left of a region in which the cutting or the hole forming is possible. The left-right direction is set as the X direction, and the front-rear direction is set as the Y direction. The cutting data and the plot data are stored in the flash memory 74 for each of a pattern, a design, or the like (hereinafter referred to as an “object”) that is a target of the cutting or the perforating.

The LCD 51 can perform notification of various commands. The detector 41 outputs the signal indicating the position, in the up-down direction, of the mounting portion 32. The drive circuits 77 to 79 respectively drive the Y-axis motor 15, the X-axis motor 25, and the Z-axis motor 34. The control portion 71 drives the Y-axis motor 15, the X-axis motor 25, and the Z-axis motor 34 via the drive circuits 77 to 79, and thus controls the conveyance portion 7, the movement portion 8, and the up-down drive mechanism 33. In this way, the control portion 71 moves the mounting portion 32 and the holding member 10 relative to each other.

Overview of operation of cutting device 1A (perforating operation)

An overview will be explained of an operation by which the cutting device 1A forms the holes, using the needle Ps, in the target object 20, in accordance with the plot data (hereinafter referred to as a “perforating operation”). First, in a state in which the needle Ps of the needle module P is separated from and above the target object 20, the control portion 71 controls the conveyance portion 7 and the movement portion 8, and moves the mounting portion 32 to a plot position indicated by the plot coordinates of the plot data. The control portion 71 controls the up-down drive mechanism 33 and moves the mounting portion 32 downward to a position at which the tip end of the needle Ps of the needle module P pierces the holding member 10. In this way, the needle Ps penetrates the target object 20 held by the holding member 10, and forms the hole in the target object 20. After that, the control portion 71 controls the up-down drive mechanism 33 and moves the mounting portion 32 upward to a position at which the needle Ps of the needle module P is separated from and above the target object 20. The above processing is performed a number of times corresponding to a number of the plot coordinates included in the plot data, and the plurality of holes are formed, using the needle Ps, in the target object 20 held by the holding member 10.

Note that the above-described perforating operation can be performed in the state in which the first holding portion 101 is held by the second holding portion 102, and the target object 20 is held by the first holding portion 101. In this case, even if the first holding portion 101 is pierced by the needle Ps at the same time as the needle Ps forms the hole in the target object 20 and a recess is formed in the first holding portion 101, due to the rubber elasticity of the urethane gel mat 10B, the recess can be eliminated. Further, due to the self-adhesive properties of the urethane gel mat 10B, the first holding portion 101 can even more effectively eliminate the recess as a result of wall portions of the recess adhering to each other. On the other hand, the above-described perforating operation cannot be performed in a state in which the target object 20 is directly held by the second holding portion 102. This is because the second holding portion 102 is harder than the first holding portion 101, and the second holding portion 102 cannot be deeply pierced by the needle Ps to a degree at which the hole of a sufficient size can be formed in the target object 20 by the needle Ps.

Overview of operation of cutting device 1A (cutting operation)

An overview will be explained of an operation by which the cutting device 1A cuts the target object 20, using the cutting blade Cs, in accordance with the cutting data (hereinafter referred to as a “cutting operation”). First, in a state in which the cutting blade Cs of the cutting module C is separated from and above the target object 20, the control portion 71 controls the conveyance portion 7 and the movement portion 8, and moves the mounting portion 32 to a start position indicated by the start coordinates of the cutting data. The control portion 71 controls the up-down drive mechanism 33 and moves the mounting portion 32 downward to a position at which the cutting blade Cs of the cutting module C comes into contact with the holding member 10. In this state, the control portion 71 controls the conveyance portion 7 and the movement portion 8, and moves the holding member 10 and the mounting portion 32 relative to each other in the X direction and the Y direction, to an end position indicated by the end coordinates of the cutting data. After that, the control portion 71 controls the up-down drive mechanism 33, and moves the mounting portion 32 upward to a position at which the cutting blade Cs of the cutting module C is separated from and above the target object 20. The above processing is performed a number of times corresponding to a number of the start coordinates and end coordinates included in the cutting data, and the target object 20 held by the holding member 10 is cut by the cutting blade Cs.

Note that the above-described cutting operation can be performed in the state in which the first holding portion 101 is held by the second holding portion 102, and the target object 20 is held by the first holding portion 101. In this case, even if a cut that is the recess is formed in the first holding portion 101 at the same time as cutting the target object 20 using the cutting blade Cs, due to the rubber elasticity of the urethane gel mat 10B, the cut can be eliminated. Further, due to the self-adhesive properties of the urethane gel mat 10B, the first holding portion 101 can even more effectively eliminate the recess as a result of the wall portions of the recess adhering to each other. Further, in contrast to the perforating operation, the above-described cutting operation can be performed in a state in which the target object 20 is directly held by the second holding portion 102. This is because a depth of the cut formed using the cutting blade Cs in the cutting operation is set to be smaller than a depth of the recess formed by the needle Ps in the perforating operation. The reason for this is that, in a state in which the cutting blade Cs has deeply cut into the holding member 10, a movement load when the cutting blade Cs and the holding member 10 are caused to move relative to each other by the conveyance portion 7 and the movement portion 8 becomes large, and it is not possible to move the cutting blade Cs and the holding member 10 relative to each other. Thus, in either case of when the holding member 10 holding the target object 20 is the first holding portion 101 or the second holding portion 102, it is possible to cause the relative movement between the cutting blade Cs and the holding member 10 in the state in which the cutting blade Cs has cut into the holding member 10.

Method for detecting contact between cutting blade Cs or needle Ps and holding member 10

The control portion 71 of the cutting device 1A can detect, using the following method, that the cutting blade Cs or the needle Ps has come into contact with the holding member 10, when the mounting portion 32 to which the cartridge 4 is mounted has moved downward.

The control portion 71 moves the mounting portion 32 downward by rotating the Z-axis motor 34 of the up-down drive mechanism 33. At this time, as shown in FIG. 2 and FIG. 3, the output shaft 40 of the Z-axis motor 34 and the gears 35 and 36 rotate, and the pressure changing member 31 transmits the rotation of the gear 36 to the plate portion 48. In a state in which the cutting blade Cs or the needle Ps is not in contact with the holding member 10 (the first holding portion 101 or the second holding portion 102), no upward pressure is applied to the mounting portion 32. Thus, in accordance with the rotation of the gear 36 being transmitted to the plate portion 48 by the pressure changing member 31, the plate portion 48 and the pinion 38 rotate by the same amount as the rotation of the gear 36. On the other hand, in a state in which the cutting blade Cs or the needle Ps has come into contact with the holding member 10, an upward pressure acts on the mounting portion 32. Thus, until a downward pressure acting on the mounting portion 32 in accordance with the rotation of the gear 36 being transmitted to plate portion 48 by the pressure changing member 31 exceeds the upward pressure applied to the mounting portion 32, the plate portion 48 and the pinion 38 do not rotate.

When the output shaft 40 of the Z-axis motor 34 further rotates, the gear 36 rotates relative to the plate portion 48 and the pinion 38, and the torsion of the pressure changing member 31 becomes greater. As a consequence of this, the downward pressure acting on the mounting portion 32 from the pressure changing member 31 via the plate portion 48 and the pinion 38 becomes greater. When the downward pressure from the pressure changing member 31 acting on the mounting portion 32 has exceeded the upward pressure applied to the mounting portion 32, the pinion 38 rotates, and the mounting portion 32 moves downward.

Here, the Z-axis motor 34 is a pulse motor, and there is a correlation between a number of pulses input to the Z-axis motor 34 and the downward pressure acting on the mounting portion 32 from the pressure changing member 31. Thus, the control portion 71 counts the number of pulses input to the Z-axis motor 34 when moving the mounting portion 32 downward, and at the same time, acquires the position of the mounting portion 32 on the basis of the signal output from the detector 41. The control portion 71 identifies, as a timing at which the cutting blade Cs or the needle Ps has come into contact with the holding member 10, a timing at which a relationship between the number of pulses and the position of the mounting portion 32 changes. Furthermore, on the basis of the position of the mounting portion 32 at this timing, the control portion 71 identifies a position (hereinafter referred to a “contact position”), in the up-down direction, of the tip end of of the cutting blade Cs or the needle Ps that is in contact with the holding member 10.

Main processing

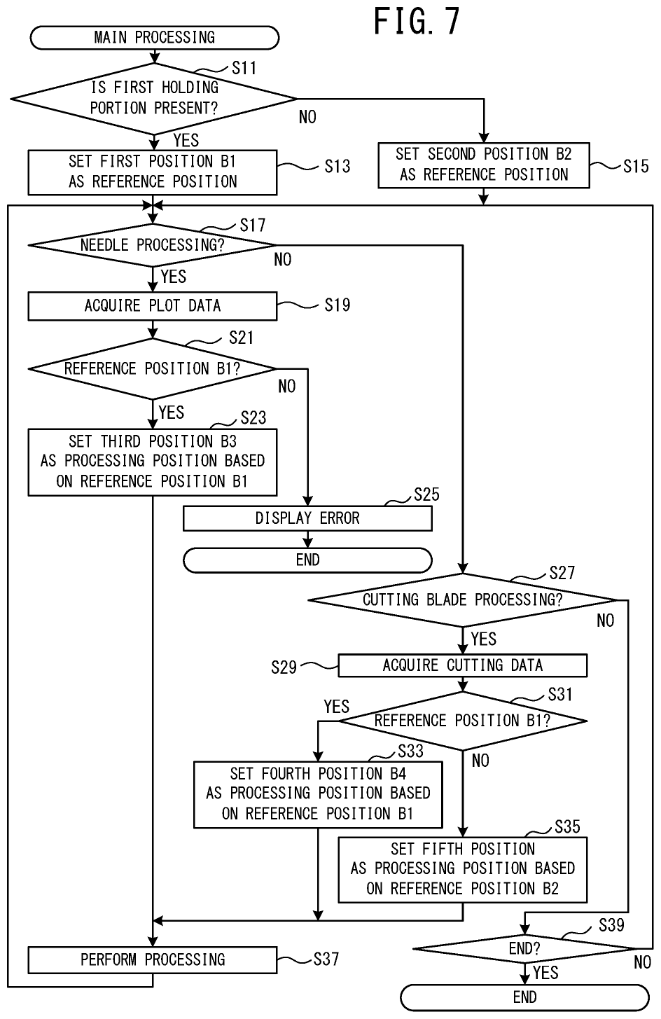

Main processing executed by the control portion 71 of the cutting device 1A will be explained with reference to FIG. 7. When an operation to switch on a power supply to the cutting device 1A is performed, the main processing is started by the control portion 71 reading out a program stored in the ROM 72 and executing the program. First, the control portion 71 identifies, by the following method, whether or not the first holding portion 101 is in a state of being held by the second holding portion 102 (S11).

The control portion 71 controls the conveyance portion 7 and the movement portion 8, and moves the mounting portion 32 to which the cartridge 4 is mounted to a position above the detection region Rd (refer to FIG. 1) of the holding member 10. The control portion 71 controls the up-down drive mechanism 33 and moves the mounting portion 32 downward. On the basis of the number of pulses input to the Z-axis motor 34 when moving the mounting portion 32 downward, and the signal output from the detector 41, the control portion 71 identifies the position, in the up-down direction, of the mounting portion 32 when the cutting blade Cs or the needle Ps has come into contact with the holding member 10. Furthermore, on the basis of the identified position of the mounting portion 32, and a gap, in the up-down direction, from the mounting portion 32 to the cutting blade Cs or the needle Ps, the control portion 71 identifies, as a contact position Qd, a position, in the up-down direction, of the tip end of the cutting blade Cs or the needle Ps when the tip end of the cutting blade Cs or the needle Ps has come into contact with the holding member 10. After that, the control portion 71 controls the up-down drive mechanism 33 and moves the mounting portion 32 upward to a position at which the cutting blade Cs or the needle Ps is separated from and above the holding member 10. Hereinafter, the above-described processing that identifies the contact position Qd is referred to as a “first process.”

Next, the control portion 71 controls the conveyance portion 7 and the movement portion 8, and moves the mounting portion 32 to which the cartridge 4 is mounted to a position above the detection region Rn (refer to FIG. 1) of the holding member 10. The control portion 71 controls the up-down drive mechanism 33 and moves the mounting portion 32 downward. Using the same method as in the first process, the control portion 71 identifies, as a contact position Qn, a position, in the up-down direction, of the tip end of the cutting blade Cs or the needle Ps when the tip end of the cutting blade Cs or the needle Ps has come into contact with the holding member 10. After that, the control portion 71 controls the up-down drive mechanism 33 and moves the mounting portion 32 upward to a position at which the cutting blade Cs or the needle Ps is separated from and above the holding member 10. Hereinafter, the above-described process to identify the contact position Qn is referred to as a “second process.”

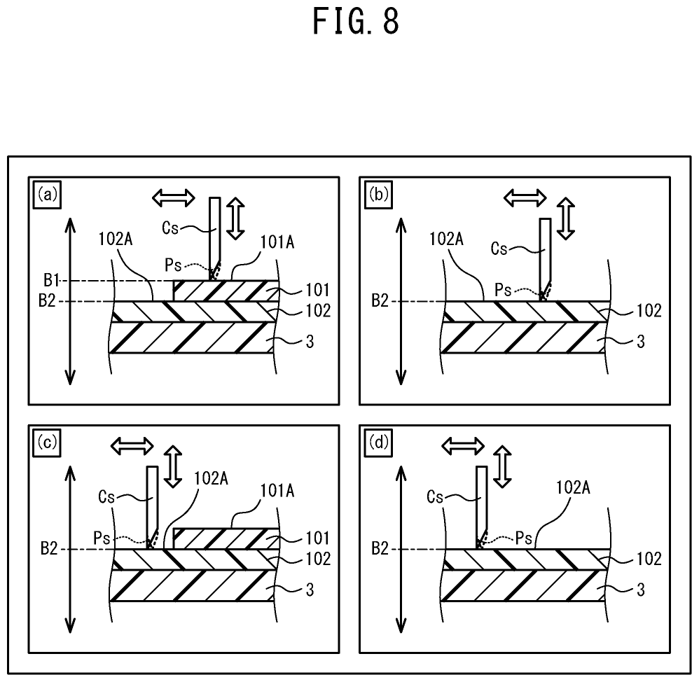

For example, when the first holding portion 101 is held by the second holding portion 102, in the first process, the cutting blade Cs or the needle Ps comes into contact with the first surface 101A of the protrusion 10T (refer to FIG. 1) of the first holding portion 101 (refer to FIG. 8(a)). In this case, the contact position Qd is denoted by a first position Bl, as shown in FIG. 8(a). Further, when the first holding portion 101 is not held by the second holding portion 102, in the first process, the cutting blade Cs or the needle Ps comes into contact with the third surface 102A of the second holding portion 102 (refer to FIG. 8(b)). In this case, the contact position Qd is denoted by a second position B2, as shown in FIG. 8(b). In this case, the second position B2 is disposed lower than the first position B1. In contrast to this, in the second process, irrespective of whether or not the first holding portion 101 is held by the second holding portion 102, the cutting blade Cs or the needle Ps comes into contact with the third surface 102A of the second holding portion 102 (refer to FIG. 8(c) and FIG. 8(d)). In this case, the contact position Qn is denoted by the second position B2 in either case, as shown in FIG. 8(c) and FIG. 8(d).

Thus, when there is a difference between the contact position Qd identified by the first process and the contact position Qn identified by the second process (refer to FIG. 8(a) and FIG. 8(c)), the control portion 71 determines that the first holding portion 101 has been held by the second holding portion 102 (yes at S11). On the other hand, when the contact position Qd identified by the first process and the contact position Qn identified by the second process match each other (refer to FIG. 8(b) and FIG. 8(d)), the control portion 71 determines that the first holding portion 101 has not been held by the second holding portion 102 (no at S11).

As shown in FIG. 7, when it is determined that the first holding portion 101 has been held by the second holding portion 102 (yes at S11), the control portion 71 sets the first position B1 identified as the contact position Qd in the first process as a reference position that is a reference when moving the mounting portion 32 up and down (S13). The control portion 71 advances the processing to S17. When it is determined that the first holding portion 101 has not been held by the second holding portion 102 (no at S11), the control portion 71 sets, as the reference position, the second position B2 that is identified as the contact positions Qn and Qd in the first process and the second process, and that is disposed lower than the first position B1 (S15). The control portion 71 advances the processing to S17.

When causing the cutting device 1A to perform the perforating operation, the user mounts the cartridge 4B to which the needle module P including the needle Ps is fixed, to the mounting portion 32 of the cutting device 1A. At this time, the needle Ps of the cartridge 4B is disposed so as to be separated from and above the holding member 10. Further, in order to perform the perforating by forming the holes in the target object 20 while using the first holding portion 101, the user causes the second surface 101B of the first holding portion 101 to come into contact with and adhere to the adhesive region of the third surface 102A of the second holding portion 102, and causes the second holding portion 102 to hold the first holding portion 101. Furthermore, the user causes the target object 20 to come into contact with and adhere to the first surface 101A of the first holding portion 101, and hold the target object 20 using the first holding portion 101. After that, the user performs a panel operation for specifying the object and instructing the start of the perforating operation.

On the other hand, when causing the cutting device 1A to perform the cutting operation, the user mounts the cartridge 4A to which the cutting module C including the cutting blade Cs is fixed, to the mounting portion 32 of the cutting device 1A. At this time, the cutting blade Cs of the cartridge 4A is disposed so as to be separated from and above the holding member 10. Further, when cutting the target object 20 while using the first holding portion 101, the user causes the second surface 101B of the first holding portion 101 to come into contact with and adhere to the adhesive region of the third surface 102A of the second holding portion 102, and causes the second holding portion 102 to hold the first holding portion 101. Furthermore, the user causes the target object 20 to come into contact with and adhere to the first surface 101A of the first holding portion 101, and hold the target object 20 using the first holding portion 101. On the other hand, when cutting the target object 20 without using the first holding portion 101, the user causes the target object 20 to come into contact with and adhere to the adhesive region of the third surface 102A of the second holding portion 102, and hold the target object 20 using the second holding portion 102. After that, the user performs a panel operation for specifying the object and instructing the start of the cutting operation.

The control portion 71 determines whether a command to start the perforating operation has been input by the panel operation (S17). When it is determined that the command to start the perforating operation has been input (yes at S17), the control portion 71 reads out and acquires, from the flash memory 74, the plot data corresponding to the specified object (S19).

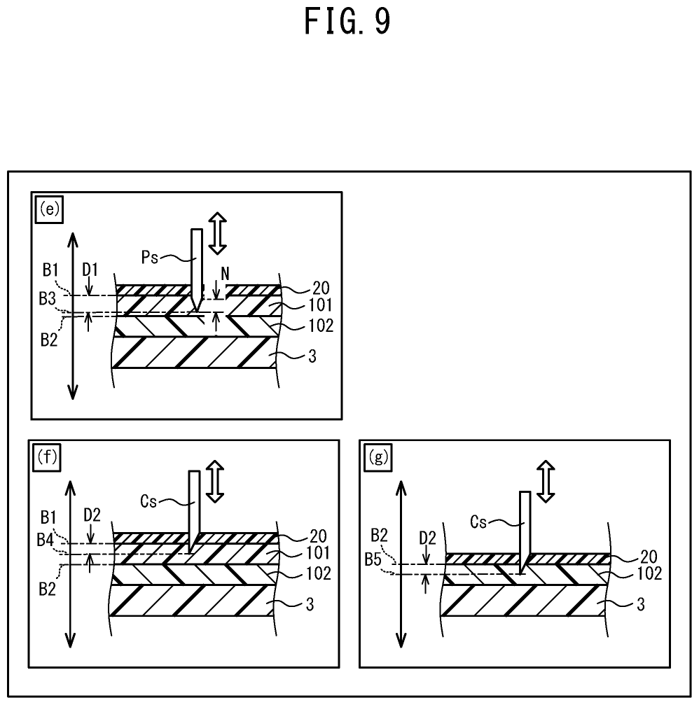

The control portion 71 determines whether the first position B1 is set as the reference position (refer to S13) (S21). When it is determined that the first position B1 is set as the reference position (yes at S21), the control portion 71 determines that the first holding portion 101 is held by the second holding portion 102, and, since the target object 20 is held by the first holding portion 101, determines that the perforating operation can be performed. In this case, the control portion 71 calculates a third position B3 (refer to FIG. 9(e)) that is separated downward by a distance D1 from the first position B1 set as the reference position. The control portion 71 sets the calculated third position B3 as the position of the tip end of the needle Ps when moving the mounting portion 32 downward in order to form the hole in the target object 20 using the needle Ps by the perforating operation (S23). The control portion 71 advances the processing to S37.

Note that the distance D1 is smaller than the thickness of the first holding portion 101. Thus, the third position B3 is disposed above the second position B2 that is the position of the third surface 102A of the second holding portion 102. As a result, when the needle Ps has pierced the first holding portion 101 as a result of the perforating operation, the tip end of the needle Ps is positioned above a section at which the second surface 101B of the first holding portion 101 and the third surface 102A of the second holding portion 102 are in contact with each other. Therefore, the needle Ps does not penetrate the first holding portion 101. Further, the distance D1 is longer than the length N in the axial direction of the second portion 67 of the needle Ps (refer to FIG. 9(e)). Thus, the hole having substantially the same diameter as the diameter of the first portion 66 of the needle Ps is formed in the target object 20 as a result of the perforating operation.

On the other hand, when it is determined that the second position B2 is set as the reference position (refer to S15) (no at S21), since the target object 20 is directly held by the second holding portion 102, the control portion 71 determines that the perforating operation cannot be performed. In this case, the control portion 71 displays, on the LCD 51, an error screen notifying that the perforating operation cannot be performed (S25). The control portion 71 ends the main processing.

When it is determined that the command to start the perforating operation has not been input (no at S17), the control portion 71 advances the processing to S27. The control portion 71 determines whether a command to start the cutting operation has been input by the panel operation (S27). When it is determined that the command to start the cutting operation has been input (yes at S27), the control portion 71 reads out and acquires, from the flash memory 74, the cutting data corresponding to the specified object (S29).

The control portion 71 determines whether the first position B1 is set as the reference position (refer to S13) (S31). When it is determined that the first position B1 is set as the reference position (yes at S31), the control portion 71 determines that the first holding portion 101 is held by the second holding portion 102, and that the target object 20 is held by the first holding portion 101, and determines that the cutting operation can be performed. In this case, the control portion 71 calculates a fourth position B4 (refer to FIG. 9(f)) that is separated downward by a distance D2 from the first position B1 set as the reference position. The control portion 71 sets the calculated fourth position B4 as the position of the tip end of the cutting blade Cs when moving the mounting portion 32 downward in order to cut the target object 20, using the cutting blade Cs, by the cutting operation (S33). The control portion 71 advances the processing to S37.

Note that the distance D2 is smaller than the distance D1 used when the third position B3 (refer to FIG. 9(e)) is calculated in the perforating operation. Thus, the fourth position B4 is disposed higher than the third position B3 that is the position of the tip end of the needle Ps when the needle Ps pierces the first holding portion 101 as a result of the perforating operation (refer to FIG. 9(e) and FIG. 9(f)).

On the other hand, when it is determined that the second position B2 is set as the reference position (refer to S15) (no at S31), the control portion 71 determines that the target object 20 is directly held by the second holding portion 102 and that the cutting operation can be performed. In this case, the control portion 71 calculates a fifth position B5 that is separated downward by the distance D2 from the second position B2 set as the reference position (refer to FIG. 9(g)). The control portion 71 sets the calculated fifth position B5 as the position of the tip end of the cutting blade Cs when moving the mounting portion 32 downward in order to cut the target object 20, using the cutting blade Cs, by the cutting operation (S35). The control portion 71 advances the processing to S37.

Hereinafter, the position of the tip end of the needle Ps when moving the mounting portion 32 downward to form the hole in the target object 20, using the needle Ps, by the perforating operation, and the position of the tip end of the cutting blade Cs when moving the mounting portion 32 downward to cut the target object 20, using the cutting blade Cs, by the cutting operation, are collectively referred to as a “processing position.” The processing position is set to be the third position B3 (refer to FIG. 9(e)) by the processing at S23, is set to be the fourth position B4 (refer to FIG. 9(f)) by the processing at S33, and is set to be the fifth position B5 (refer to FIG. 9(g)) by the processing at S35.

The control portion 71 performs the perforating operation or the cutting operation (S37). When the perforating operation is performed, the control portion 71 controls the conveyance portion 7 and the movement portion 8 and moves the mounting portion 32 to the plot position indicated by the plot coordinates of the plot data. The control portion 71 controls the up-down drive mechanism 33 and moves the mounting portion 32 downward until the tip end of the needle Ps of the needle module P reaches the processing position (the third position B3). In this way, the hole is formed in the target object 20 in the state in which the first holding portion 101 is held by the second holding portion 102, and the target object 20 is held by the first holding portion 101. After that, the control portion 71 controls the up-down drive mechanism 33, and moves the mounting portion 32 upward to a position at which the needle Ps of the needle module P is above and separated from the holding member 10. The above-described processing is repeated the number of times corresponding to the number of plot coordinates included in the plot data acquired by the processing at S19.

On the other hand, when the cutting operation is performed, the control portion 71 controls the conveyance portion 7 and the movement portion 8 and moves the mounting portion 32 to the start position indicated by the start coordinates of the cutting data. The control portion 71 controls the up-down drive mechanism 33 and moves the mounting portion 32 downward until the tip end of the cutting blade Cs of the cutting module C reaches the processing position (the fourth position B4 or the fifth position B5). Note that the processing position in the state in which the first holding portion 101 is held by the second holding portion 102 and the target object 20 is held by the first holding portion 101 is the fourth position B4, and the processing position in the state in which the target object 20 is directly held by the second holding portion 102 is the fifth position B5. In this state, the control portion 71 controls the conveyance portion 7 and the movement portion 8, and moves the holding member 10 and the mounting portion 32 relative to each other in the X direction and the Y direction until the end position indicated by the end coordinates of the cutting data. After that, the control portion 71 controls the up-down drive mechanism 33 and moves the mounting portion 32 upward to a position at which the cutting blade Cs of the cutting module C is above and separated from the holding member 10. The above-described processing is repeated the number of times corresponding to the number of start coordinates and end coordinates included in the cutting data acquired by the processing at S29.

When the perforating operation or the cutting operation by the processing at S37 has ended, the control portion 71 returns the processing to S17.

For example, after performing the perforating operation (S19 to S23, S37), when performing the cutting operation on the target object 20 that is held by the first holding portion 101 and in which the hole has been formed by the needle Ps, the user removes the cartridge 4B to which the needle module P including the needle Ps is fixed, from the mounting portion 32, and in its place, mounts the cartridge 4A to which the cutting module C including the cutting blade Cs is fixed, to the mounting portion 32. After that, the user performs the panel operation to specify the object and command the start of the cutting operation. In this case, the control portion 71 performs the cutting operation (S29 to S35, S37), and cuts the target object 20 held by the first holding portion 101, using the cutting blade Cs. In this case, from the start of the perforating operation, to the end of the cutting operation, the state is maintained in which the target object 20 is held by the first holding portion 101.

Further, after performing the cutting operation (S29 to S35, S37), when performing the perforating operation on the target object 20 that is held by the first holding portion 101 and that has been cut by the cutting blade Cs, the user removes the cartridge 4A to which the cutting module C including the cutting blade Cs is fixed, from the mounting portion 32, and in its place, mounts the cartridge 4B to which the needle module P including the needle Ps is fixed, to the mounting portion 32. After that, the user performs the panel operation to specify the object and command the start of the perforating operation. In this case, the control portion 71 performs the perforating operation (S21 to S23, S37), and forms the hole, using the needle Ps, in the target object 20 held by the first holding portion 101. In this case, from the start of the cutting operation to the end of the perforating operation, the state is maintained in which the target object 20 is held by the first holding portion 101.

When it is determined that the command to start the perforating operation and the cutting operation has not been input by the panel operation (no at S17, no at S27), the control portion 71 determines whether the command to end the perforating operation and the cutting operation has been input by the panel operation (S39). When it is determined that the command to end the perforating operation and the cutting operation has not been input by the panel operation (no at S39), the control portion 71 returns the processing to S17. When it is determined that the command to end the perforating operation and the cutting operation has been input by the panel operation (yes at S39), the control portion 71 ends the main processing.

Experiment Results

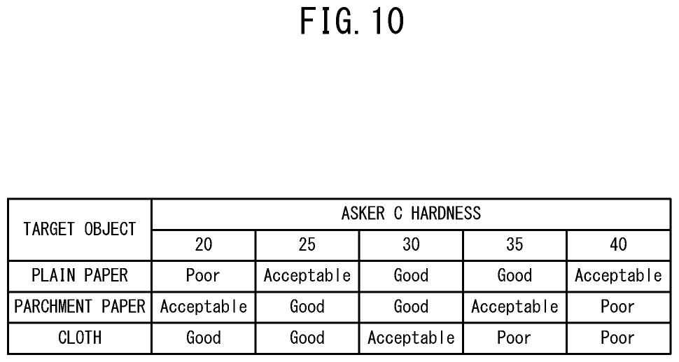

Results of evaluations of characteristics (during cutting or during perforating) of the urethane gel mat 10B of the first holding portion 10 will be explained, with reference to FIG. 10 to FIG. 13.

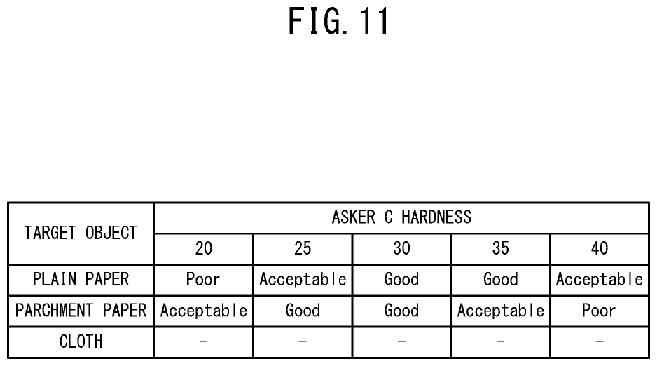

FIG. 10 and FIG. 11 show results of evaluations performed of the adhesive properties of the urethane gel mat 10B with respect to various target objects (plain paper, parchment paper, cloth) at the time of the cutting operation (refer to FIG. 10) and at the time of the perforating operation (refer to FIG. 11), for each of Asker C hardnesses (hereinafter simply referred to as the “hardness”) of the urethane gel mat 10B (refer to FIG. 4). As a sample, the urethane gel mat 10B having an adhesive force of 1.5 (N/25 mm) was used. The adhesive properties were measured in three stages of “Good” (favorable), “Acceptable” (generally favorable), and “Poor” (somewhat inferior). Evaluation criteria were as follows:
(1) Whether or not the target object 20 could be held by the urethane gel mat 10B when performing processing, by the cutting operation or the perforating operation, on the target object 20 held by the urethane gel mat 10B, and
(2) Whether or not, when removing the target object 20 from the urethane gel mat 10B after the cutting operation or the perforating operation, the target object 20 could be removed without causing curling.
FIG. 10 (the cutting operation) and FIG. 11 (the perforating operation) differ in whether the evaluated target object 20 included the cloth or not. The cloth is included in the target object 20 that is the target of the cutting operation (refer to FIG. 10), but the cloth is not included in the target object 20 that is the target of the perforating operation (refer to FIG. 11). This is because, normally, cloth is not used as the target object 20 that is the object of the perforating operation. Note that, generally, the lower the hardness, the greater the adhesive properties, and the more strongly the target object 20 can be adhered to the urethane gel mat 10B. On the other hand, when the hardness is too low, the more difficult it is to remove the target object 20 from the urethane gel mat 10B, which is not preferable.

As shown in FIG. 10 and FIG. 11, when the plain paper was used as the target object 20, when the hardness of the urethane gel mat 10B was from 25 to 40, results were obtained in which the target object 20 (the plain paper) was easily adhered to and removed from the urethane gel mat 10B (good or acceptable). Furthermore, when the hardness of the urethane gel mat 10B was from 30 to 35, results were obtained in which the target object 20 (the plain paper) was easily adhered to and removed from the urethane gel mat 10B in an even more favorable manner (good). When the parchment paper was used as the target object 20, when the hardness of the urethane gel mat 10B was from 20 to 35, results were obtained in which the target object 20 (the parchment paper) was easily adhered to and removed from the urethane gel mat 10B (good or acceptable). Furthermore, when the hardness of the urethane gel mat 10B was from 25 to 30, results were obtained in which the target object 20 (the parchment paper) was easily adhered to and removed from the urethane gel mat 10B in an even more favorable manner (good). As shown in FIG. 10, when the cloth was used as the target object 20, when the hardness of the urethane gel mat 10B was from 20 to 30, results were obtained in which the target object 20 (the cloth) was easily adhered to and removed from the urethane gel mat 10B (good or acceptable). Furthermore, when the hardness of the urethane gel mat 10B was from 20 to 25, results were obtained in which the target object 20 (the cloth) was easily adhered to and removed from the urethane gel mat 10B in an even more favorable manner (good).

From the above-described results, it was clear that the Asker C hardness of the urethane gel mat 10B is preferably from 20 to 40, and more preferably, is from 25 to 35, and it is possible to form the urethane gel mat 10B to which the target object 20 is easily adhered and from which the target object 20 is easily removed in all circumstances, irrespective of the processing method (the cutting operation or the perforating operation) dand the type of the target object 20.

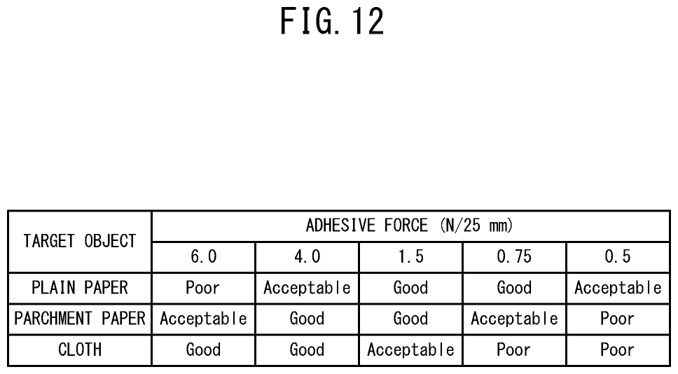

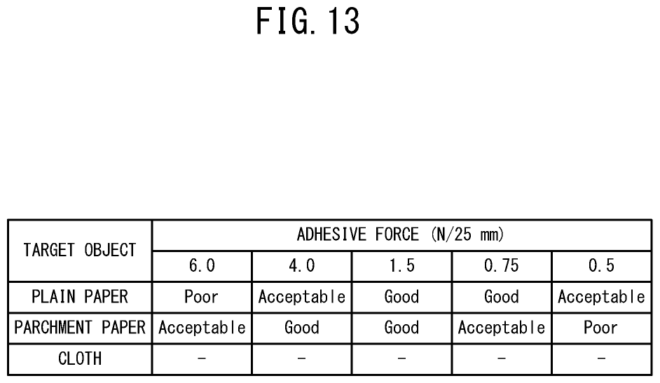

FIG. 12 and FIG. 13 show results when the adhesive properties were evaluated, in the cutting operation (refer to FIG. 12) and the perforating operation (refer to FIG. 13) of each of the target objects (the plain paper, the parchment paper, and the cloth) with respect to the urethane gel mat 10B, for each of adhesive forces (unit: N/25 mm) of the urethane gel mat 10B (refer to FIG. 4). As a sample, the urethane gel mat 10B having the Asker C hardness of 30 was used. The evaluation criteria ((1) and (2) described above), the evaluation stages (“Good,” “Acceptable,” and “Poor”), and the difference between FIG. 12 and FIG. 13 were the same as for the above-described evaluation results (refer to FIG. 10 and FIG. 11) of the Asker C hardness. Generally, the greater the adhesive force, the more strongly the target object 20 can be adhered to the urethane gel mat 10B. On the other hand, when the adhesive force is too strong, the more difficult it is to remove the target object 20 from the urethane gel mat 10B, which is not preferable.

Note that the measurement of the adhesive force was performed in compliance with JIS Z0237. Further, adhesive properties were measured in the three stages of “Good,” “Acceptable,” and “Poor” when the target object 20 was peeled from the urethane gel mat 10B under peeling conditions of a peeling velocity of 300 mm/min and 180° peeling, after applying pressure back and forth once, using a 2 kg rubber roller, to the target object 20 and the urethane gel mat 10B. Further, the evaluation of the adhesive properties was performed at an ambient temperature of 20° C.

As shown in FIG. 12 and FIG. 13, when the plain paper was used as the target object 20, when the adhesive force of the urethane gel mat 10B was from 0.5 to 4.0 (N/25 mm), results were obtained in which the target object 20 (the plain paper) was easily adhered to and removed from the urethane gel mat 10B (good or acceptable). Furthermore, when the adhesive force of the urethane gel mat 10B was from 0.75 to 1.5 (N/25 mm), results were obtained in which the target object 20 (the plain paper) was easily adhered to and removed from the urethane gel mat 10B in an even more favorable manner (good). When the parchment paper was used as the target object 20, when the adhesive force of the urethane gel mat 10B was from 0.75 to 6.0 (N/25 mm), results were obtained in which the target object 20 (the parchment paper) was easily adhered to and removed from the urethane gel mat 10B (good or acceptable). Furthermore, when the adhesive force of the urethane gel mat 10B was from 1.5 to 4.0 (N/5 mm), results were obtained in which the target object 20 (the parchment paper) was easily adhered to and removed from the urethane gel mat 10B in an even more favorable manner (good). As shown in FIG. 12, when the cloth was used as the target object 20, when the adhesive force of the urethane gel mat 10B was from 1.5 to 6.0 (N/25 mm), results were obtained in which the target object 20 (the cloth) was easily adhered to and removed from the urethane gel mat 10B (good or acceptable). Furthermore, when the adhesive force of the urethane gel mat 10B was from 4.0 to 6.0 (N/25 mm), results were obtained in which the target object 20 (the cloth) was easily adhered to and removed from the urethane gel mat 10B in an even more favorable manner (good).

From the above-described results, it was clear that the adhesive force of the urethane gel mat 10B is preferably from 0.5 N/25 mm to 6.0N/25 mm at an ambient temperature of 20° C., and more preferably, is from 0.75 N/25 mm to 4.0 N/25 mm at an ambient temperature of 20° C., and it is possible to form the urethane gel mat 10B to which the target object 20 is easily adhered and from which the target object 20 is easily removed in all circumstances, irrespective of the processing method (the cutting operation or the perforating operation) and the type of the target object 20.

Actions and Effects of Present Embodiment

In the cutting device 1A, the target object 20 is held on the first surface 101A of the first holding portion 101 including the urethane gel mat 10B configured by the elastomer gel. Since the elastomer gel has self-adhesive properties, the target object 20 is favorably held on the first surface 101A at which the urethane gel mat 10B, of the first holding portion 101, is exposed. Further, since the elastomer gel has rubber elasticity, a recess formed in the first holding portion 101 when the cutting blade Cs or the needle Ps penetrates the target object 20 and pierces the first holding portion 101 is eliminated, after the cutting blade Cs or the needle Ps is removed from the first holding portion 101, by the side walls of the recess adhering to each other. Thus, a holding capability of the first holding portion 101 is maintained. As a result, by controlling the up-down drive mechanism 33, the conveyance portion 7, and the movement portion 8, with respect to the target object 20 held appropriately by the first holding portion 101, the cutting device 1A can form the plurality of holes using the needle Ps, or can cut the target object 20 using the cutting blade Cs. Therefore, the cutting device 1A can appropriately perform the cutting operation or the perforating operation.

The urethane gel mat 10B of the first holding portion 101 is configured by the urethane elastomer gel. The urethane elastomer gel has superior characteristics in terms of rubber elasticity, mechanical strength, wear resistance, flex resistance and the like. Thus, in comparison to a case in which a material other than the urethane elastomer gel is used as the material of the urethane gel mat 10B of the first holding portion 101, the cutting device 1A can even more favorably maintain the holding capability of the first holding portion 101. Further, the cutting device 1A can increase the durability of the first holding portion 101. Furthermore, the cutting device 1A can prevent the first holding portion 101 from deforming in the course of opening the holes in the target object 20, or in the course of cutting the target object 20.

The surface area of the second holding portion 102 of the holding member 10 is larger than that of the first holding portion 101. Further, the adhesive region of the third surface 102A of the second holding portion 102 has adhesive properties. Thus, the second holding portion 102 can favorably hold the first holding portion 101 by causing the adhesive region of the third surface 102A to come into contact with the second surface 101B of the first holding portion 101, and can suppress the first holding portion 101 from becoming displaced with respect to the second holding portion 102. Further, the non-adhesive film 10E is exposed at the second surface 101B of the first holding portion 101 and has the nonadherent properties. Thus, the cutting device 1A can perform the processing on the target object 20 in the state in which the first holding portion 101 is detached from the second holding portion 102. As a result, for example, when processing the target object 20 using a processing method (the cutting operation, for example) in which the first holding portion 101 is not necessary, the cutting device 1A can easily remove the first holding portion 101 from the second holding portion 102.

When the cutting device 1A is used in the state in which the first holding portion 101 is held by the second holding portion 102, the target object 20 is held by the first holding portion 101. On the other hand, when the cutting device 1A is used in the state in which the first holding portion 101 is not held by the second holding portion 102, the target object 20 is directly held by the second holding portion 102. Here, the position of the target object 20 in the up-down direction differs in the respective cases. Therefore, when the cutting device 1A performs the cutting operation, it is necessary to adjust the position of the tip end of the cutting blade Cs (the processing position) when the mounting portion 32 has been moved downward, in accordance with whether or not the first holding portion 101 is being held by the second holding portion 102. With respect to this, the cutting device 1A determines whether or not the first holding portion 101 is being held by the second holding portion 102 (S11), and, in accordance with the determination result, changes the reference position that is the reference when moving the mounting portion 32 in the up-down direction (S13, S15). The cutting device 1A changes the processing position in accordance with the reference position (S29, S31). As a result, the cutting device 1A can appropriately cut the target object 20 irrespective of whether or not the first holding portion 101 is used.

The Asker C hardness of the urethane gel mat 10B of the first holding portion 101 is from 20 to 40. In this case, the first holding portion 101 can suppress the target object 20 from being displaced from the first holding portion 101 during the processing of the target object 20. Further, with the first holding portion 101, the target object 20 can be easily removed from the first holding portion 101 after the processing. Further, the Asker C hardness of the urethane gel mat 10B of the first holding portion 101 is more preferably from 25 to 35. In this case, the first holding portion 101 can even more favorably suppress the target object 20 from being displaced from the first holding portion 101 during the processing. Further, with the first holding portion 101, the target object 20 can be even more easily removed from the first holding portion 101 after the processing.

The adhesive force of the urethane gel mat 10B of the first holding portion 101 is from 0.5 N/25 mm to 6.0 N/25 mm at 20° C. In this case, the first holding portion 101 can suppress the target object 20 from being displaced from the first holding portion 101 during the processing of the target object 20. Further, with the first holding portion 101, the target object 20 can be easily removed from the first holding portion 101 after the processing. Further, the adhesive force of the first holding portion 101 is more preferably from 0.75 N/25 mm to 4.0 N/25 mm at 20° C. In this case, the first holding portion 101 can even more favorably suppress the target object 20 from being displaced from the first holding portion 101 during the processing. Further, with the first holding portion 101, the target object 20 can be even more easily removed from the first holding portion 101 after the processing.

The needle Ps includes the first portion 66 in which the diameter is the same in the axial direction, and the second portion 67 that is disposed further to the tip end side than the first portion 66, and in which the diameter becomes smaller toward the tip end in the axial direction. Note that, during the perforating operation, in order to form the hole of the sufficient size in the target object 20, it is necessary to move the needle Ps downward until the first portion 66 of the needle Ps penetrates the target object 20. In this case, the second portion 67 of the needle Ps pierces the first holding portion 101. With respect to this, the thickness of the urethane gel mat 10B of the first holding portion 101 is substantially the same as the length N in the axial direction of the second portion 67 of the needle Ps. Thus, the thickness of the first holding portion 101 is greater than the length N in the axial direction of the second portion 67 of the needle Ps. For that reason, during the perforating operation, the cutting device 1A can reduce the possibility of the needle Ps, which has penetrated the target object 20 and pierced the first holding portion 101, penetrating the first holding portion 101.

Sometimes the cutting operation (S29 to S35, S37) is performed continuously after the perforating operation (S21 to S23, S37) has ended, or the perforating operation is performed continuously after the cutting operation has ended. In these cases, during the period from when the former operation is started to when the latter operation ends, the state of the target object 20 held by the first holding portion 101 is maintained. In this case, it is possible to reduce the possibility that the target object 20 becomes displaced with respect to the first holding portion 101 between the two different operations.

When performing the perforating operation using the needle Ps in the state in which the target object 20 is held by the first holding portion 101, the position of the tip end of the needle Ps when the mounting portion 32 has been moved downward in order to form the hole in the target object 20 using the needle Ps (the processing position) is set as the third position B3 (S23). On the other hand, when performing the cutting operation using the cutting blade Cs in the state in which the target object 20 is held by the first holding portion 101, the position of the tip end of the cutting blade Cs when the mounting portion 32 has been moved downward in order to appropriately cut the target object 20 using the cutting blade Cs (the processing position) is set as the fourth position B4 that is higher than the third position B3 (S33). In other words, the depth to which the cutting blade Cs cuts into the first holding portion 101 during the cutting is smaller than the depth to which the needle Ps pierces the first holding portion 101 in the perforating operation. Thus, the cutting device 1A can suppress the movement of the cutting blade Cs from being obstructed as a result of the cutting blade Cs cutting significantly into the urethane gel mat 10B of the first holding portion 101 at the same time as cutting the target object 20 using the cutting blade Cs.

Modified Examples

The present disclosure is not limited to the above-described embodiment and various modifications are possible. The cutting device 1A may be a dedicated device (a hole forming device, for example) for realizing the function of forming the hole in the target object 20 using the needle Ps. Further, the cutting device 1A may be a dedicated device for realizing the function of cutting the target object 20 using the cutting blade Cs. The first holding portion 101 may be formed by the urethane gel mat 10B alone. In this case, the first holding portion 101 need not necessarily include any of the base film 10C, the adhesive layer 10D, and the non-adhesive film 10E.

Both surfaces of the second surface 101B of the first holding portion 101 and the third surface 102A of the second holding portion 102 may have adhesive properties. The second surface 101B of the first holding portion 101 only may have the adhesive properties, and the third surface 102A of the second holding portion 102 may have the nonadherent properties. The first holding portion 101 and the second holding portion 102 may have the same surface area, respectively. The cutting device 1A may include only the first holding portion 101 as the holding member 10, and need not necessarily include the second holding portion 102. The conveyance portion 7 may directly convey the first holding portion 101 in the front-rear direction.

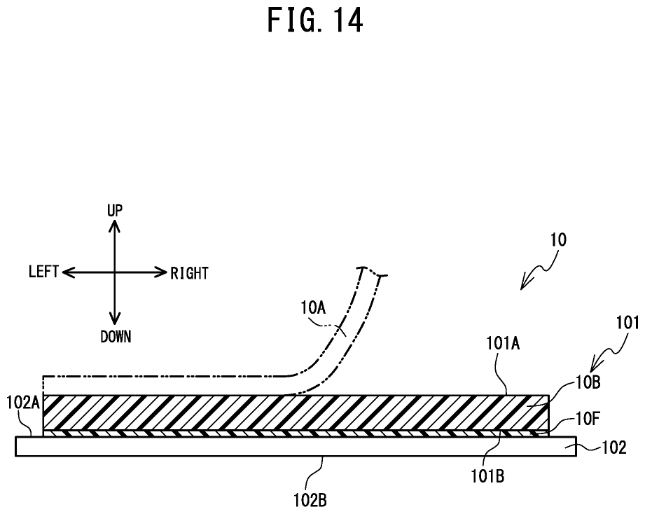

For example, when the first holding portion 101 is formed only of the urethane gel mat 10B, as shown in FIG. 14, an adhesive layer 10F that is formed of an adhesive may be interposed between the first holding portion 101 and the second holding portion 102. The adhesive of the adhesive layer 10F may adhere the second surface 101B of the first holding portion 101 (the urethane gel mat 10B) and the third surface 102A of the second holding portion 102. In contrast to the above-described embodiment, the first holding portion 101 and the second holding portion 102 may be integrated to form the holding member. The first holding portion 101 may be formed so as not to be able to be removed from the second holding portion 102.

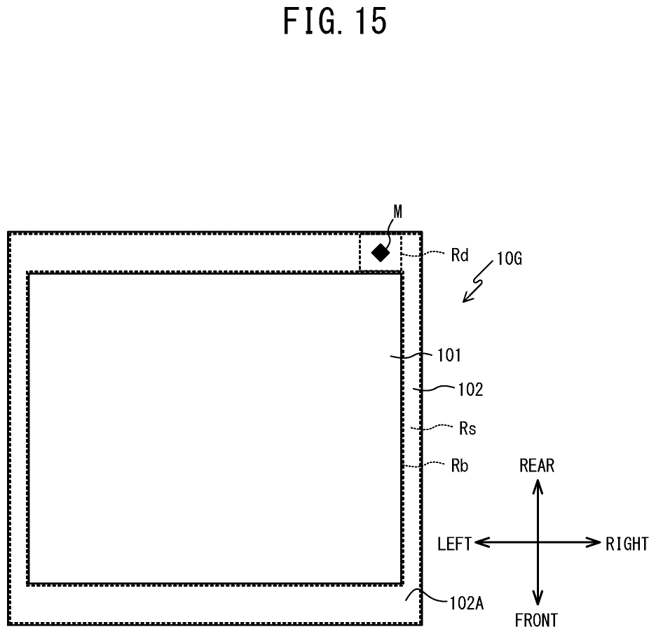

Further, as shown in FIG. 15, the lengths of the second holding portion 102 in the front-rear direction and the left-right direction may be longer, respectively, than the lengths of the first holding portion 101 in the front-rear direction and the left-right direction. When the holding member 10 is viewed from above, the peripheral end portions of the first holding portion 101 may be disposed further to the inside than the peripheral end portions of the second holding portion 102. The first holding portion 101 may be surrounded by the peripheral end portions of the second holding portion 102. The surface area of the second holding portion 102 may be larger than that of the first holding portion 101. In this case, the adhesive of the adhesive layer 10F shown in FIG. 14 may be provided in a region (hereinafter referred to as an “adhesive region Rb”), of the third surface 102A of the second holding portion 102 excluding a peripheral edge portion Rs. The first holding portion 101 may be adhered by the adhesive to the second holding portion 102, at the adhesive region Rb of the third surface 102A of the second holding portion 102.

Furthermore, when, by the cutting device 1A, a holding member in which the first holding portion 101 and the second holding portion 102 are integrally formed as shown in FIG. 14 and FIG. 15 (hereinafter referred to as an “integrated holding member 10G”) is distinguished from a holding member that is used when the target object 20 is directly held by the second holding portion 102 (hereinafter referred to as an “individual holding portion”), the cutting device 1A may identify the respective holding members in the following manner.

For example, as shown in FIG. 15, a mark M having a predetermined shape may be applied at a predetermined position of the peripheral edge portion Rs of the integrated holding member 10G (a position corresponding to the detection region Rd in the above-described embodiment, for example). The mark M indicates that this is the holding member in which the first holding portion 101 is held by the second holding portion 102. The cutting device 1A may include an optical sensor that is capable of detecting the mark M. The optical sensor may be a camera provided in the head 5, or may be a scanner provided in the vicinity of the platen 3.

When the mark M has been detected by the optical scanner, this means that the integrated holding member 10G is being used, and thus, the control portion 71 of the cutting device 1A may determine that the state is obtained in which the first holding portion 101 is held by the second holding portion 102 (yes at S11). In this case, the control portion 71 may set the first position B1 as the reference position (S13). On the other hand, when the mark M is not detected by the optical sensor, this means that the individual holding portion is being used, and thus, the control portion 71 may determine that the state is not obtained in which the first holding portion 101 is held by the second holding portion 102 (no at S11). In this case, the control portion 71 may set the second position B2 as the reference position (S15).

The mark M may be applied not only to the integrated holding member 10G, but also to the individual holding portion. In this case, the respective shapes of the mark M applied to the integrated holding member 10G and of the mark M applied to the individual holding portion may be different. By identifying the shape of the respective marks M, the control portion 71 may determine whether the integrated holding member 10G is being used, or the individual holding portion is being used. Furthermore, the shape of the mark M applied to the integrated holding member 10G may be different in accordance with the thickness of the first holding portion 101 held by the second holding portion 102. In this case, when it is determined that the state is obtained in which the first holding portion 101 is held by the second holding portion 102 (yes at S11), the control portion 71 may set the first position that is prescribed in advance for each of the shapes of the mark M.

At S17, the control portion 71 determines whether the command to start the perforating operation has been input by the panel operation. In place of this, the control portion 71 may determine whether the cartridge 4B to which the needle module P including the needle Ps is fixed, is mounted to the mounting portion 32. In this case, the control portion 71 may shift the processing to S19 when it is determined that the cartridge 4B is mounted to the mounting portion 32. On the other hand, when it is determined that the cartridge 4B is not mounted to the mounting portion 32, the control portion 71 may shift the processing to S27. In a similar manner, at S27, the control portion 71 determines whether the command to start the cutting operation has been input by the panel operation. In place of this, the control portion 71 may determine whether the cartridge 4A to which the cutting module C including the cutting blade Cs is fixed, is mounted to the mounting portion 32. In this case, the control portion 71 may shift the processing to S29 when it is determined that the cartridge 4A is mounted to the mounting portion 32. On the other hand, when it is determined that the cartridge 4A is not mounted to the mounting portion 32, the control portion 71 may shift the processing to S39. Note that the determination as to which of the cartridges 4A and 4B is mounted to the mounting portion 32 of the cutting device 1A may be performed in the following manner. For example, the cutting device 1A may include, on the mounting portion 32, a sensor that is capable of outputting a signal indicating an identification result of identifying the type of the cartridge 4 mounted to the mounting portion 32. The control portion 71 may determine which of the cartridges 4A and 4B is mounted, depending on the signal output by this sensor. The cutting device 1A may be configured to be able to perform the perforating operation in the state in which the target object 20 is directly held by the second holding portion 102.

The determination method as to whether or not the first holding portion 101 is being held by the second holding portion 102 is not limited to the above-described method. For example, the control portion 71 may determine that the first holding portion 101 is being held by the second holding portion 102 when the contact position Qd identified by the first process matches the first position B1 stored in advance in the flash memory 74. On the other hand, the control portion 71 may determine that the first holding portion 101 is not being held by the second holding portion 102 when the contact position Qd identified by the first process matches the second position B2 stored in advance in the flash memory 74.

Numerical ranges of the hardness and the adhesive force of the urethane gel mat 10B are not limited to those of the above-described embodiment, and it goes without saying that the numerical ranges may be changed other values.

The length N in the axial direction of the second portion 67 of the needle Ps may be smaller than the thickness of the urethane gel mat 10B. Further, the length N in the axial direction of the second portion 67 of the needle Ps may be greater than the thickness of the first holding portion 101 that includes the urethane gel mat 10B. The needle Ps may include only the first portion 66 that has the same diameter in the axial direction, and need not necessarily include the second portion 67.

For example, there is a case in which the perforating operation is performed after performing the cutting operation in the state in which the target object 20 is directly held by the second holding portion 102. In this case, after the cutting operation, the user removes the target object 20 from the second holding portion 102, adheres the first holding portion 101 to the second holding portion 102, holds the target object 20 using the adhered first holding portion 101, and starts the perforating operation by the cutting device 1A in this state. In this case, before the perforating operation is started, the control portion 71 may determine whether or not the state is obtained in which the first holding portion 101 is held by the second holding portion 102 by performing the processing at S11.

When the perforating operation is performed on the thick target object 20, the cutting device 1A may cause the mounting portion 32 to reciprocate in the up-down direction and may form the hole in the target object 20 by repeatedly piercing the target object 20 with the needle Ps in the same position. In this case, the processing position that is the position of the tip end when the needle Ps has been moved downward may be moved gradually downward each time the piercing operation by the needle Ps is repeated, until the processing position eventually reaches the third position B3. Further, when the cutting operation is performed on the thick target object 20, the cutting device 1A may cut the target object 20 by repeatedly moving the mounting portion 32 in the X direction and the Y direction from the start coordinates to the end coordinates, and forming cuts, using the cutting blade Cs, a plurality of times in the target object 20. In this case, the processing position that is the position of the tip end when the cutting blade Cs has been moved downward, may be moved gradually downward each time the operation to form the cut, using the cutting blade Cs, is repeated, until the processing position eventually reaches the fourth position B4 or the fifth position B5.

What is claimed is:

1. A processing device that performs processing on a target object by penetrating the target object using a processing tool, the processing device comprising:
a mounting portion to which the processing tool is mountable;
a holding member including at least a first holder, the first holder having a plate shape and being configured by an elastomer gel having self-adhesive properties, and being able to hold the target object at a first surface of the first holder;
a first mover configured to move a mounting portion, to which the processing tool is mounted, in a first direction, the first mover moving the processing tool in a direction toward the holding member when the mounting portion has moved to one side in the first direction, and moving the processing tool in a direction separating from the holding member when the mounting portion has moved to another side in the first direction;
a second mover configured to move the mounting portion and the holding member relative to each other, in a second direction and a third direction orthogonal to the first direction and orthogonal to each other;
a processor configured to control the first mover and the second mover and move the mounting portion and the holding member relative to each other; and
a memory configured to store computer-readable instructions that, when executed by the processor, instruct the processor to perform processes comprising:
acquiring processing data representing control conditions of the first mover and the second mover for causing the processing tool to penetrate the target object and perform processing on the target object; and
controlling the first mover and the second mover, on the basis of the acquired processing data, in a state in which the target object is held by the first holder, to cause the processing tool to penetrate the target object and perform the processing on the target object.

2. The processing device according to claim 1, wherein
the first holder is configured by a urethane elastomer gel.

3. The processing device according to claim 1, wherein
a second surface, which is a surface on the opposite side from the first surface of the first holder, has nonadherent properties,
the holding member further includes a second holder configured to hold the first holder, the second holder has a plate shape,
a surface area of the second holder is larger than a surface area of the first holder,
a third surface that is one surface of the second holder has adhesive properties,
the third surface holds the first holder by being caused to come into contact with the second surface of the first holder,
the first holder is removable from the second holder, and
the second mover causes the mounting portion and the first holder to move relative to each other by moving the second holder holding the first holder.

4. The processing device according to claim 3, wherein
a cutting blade as the processing tool is mountable to the mounting portion,
the second holder is capable of holding the target object, at the third surface, when the first holder has been removed, and
the computer-readable instructions further instruct the processor to perform processes comprising:
identifying whether the first holder is held by the second holder,
setting a first position as a reference position when it is identified that the first holder is being held, the reference position being a position used as a reference when moving the mounting portion in the first direction, and setting, as the reference position, a second position further to the one side in the first direction than the first position, when it is identified that the first holder is not being held,
setting, on the basis of one of the first position and the second position, a cutting position to which the mounting portion is moved by controlling the first mover and moving the mounting portion to the one side in the first direction,
acquiring, as the processing data, cutting data representing control conditions of the first mover and the second mover for cutting the target object using the cutting blade, and
penetrating the target object with the cutting blade and cutting the target object, on the basis of the set cutting position and the acquired cutting data.

5. The processing device according to claim 1, wherein
a cutting blade as the processing tool is mountable to the mounting portion, and
the computer-readable instructions further instruct the processor to perform processes comprising:
acquiring, as the processing data, cutting data representing control conditions of the first mover and the second mover for cutting the target object using the cutting blade, and
controlling the first mover and the second mover, on the basis of the acquired cutting data, in a state in which the target object is held by the first holder, and cutting the target object.

6. The processing device according to claim 1, wherein
a needle as the processing tool is mountable to the mounting portion, and
the computer-readable instructions further instruct the processor to perform processes comprising:
acquiring, as the processing data, plot data representing control conditions of the first mover and the second mover for forming a hole in the target object by the needle piercing the target object, and
controlling the first mover and the second mover, on the basis of the acquired plot data, in a state in which the target object is held by the first holder, and forming the hole in the target object.

7. The processing device according to claim 6, wherein
the needle includes
a first portion having the same diameter in an axial direction, and
a second portion positioned further to a tip end side than the first portion, and having a diameter that becomes smaller in the axial direction toward a tip end in the axial direction, and
a thickness of the first holder is larger than a length, in the axial direction, of the second portion of the needle.

8. The processing device according to claim 6, wherein
a cutting blade as the processing tool is mountable to the mounting portion,
the computer-readable instructions further instruct the processor to perform processes comprising:
performing a first process of controlling the first mover and the second mover to process the target object using one of the needle and the cutting blade mounted to the mounting portion, in a state in which the target object is held by the first holder, and
performing, after the first process, a second process of controlling the first mover and the second mover to process the target object using the other of the needle and the cutting blade mounted to the mounting portion, in the state in which the target object is held by the first holder, and
the state of the target object being held by the first holder is maintained from a start of the first process to an end of the second process.

9. The processing device according to claim 6, wherein
a cutting blade as the processing tool is mountable to the mounting portion,
the computer-readable instructions further instruct the processor to perform processes comprising:
when processing is to be performed to form the hole in the target object by the needle, setting a third position as a position of an end portion on the one side in the first direction of the needle, when the mounting portion mounted with the needle has been moved to the one side in the first direction by controlling the first mover, and
when processing is to be performed to cut the target object by the cutting blade, setting a fourth position, which is further to the other side in the first direction than the third position, as a position of an end portion on the one side in the first direction of the cutting blade, when the mounting portion mounted with the cutting blade has been moved to the one side in the first direction by controlling the first mover.

10. The processing device according to claim 1, wherein
the Asker C hardness of the first holder is from 20 to 40.

11. The processing device according to claim 1, wherein
the Asker C hardness of the first holder is from 25 to 35.

12. The processing device according to claim 6, wherein
an adhesive force of the first holder is from 0.5 N/25 mm to 6.0 N/25 mm when at 20° C.

13. The processing device according to claim 12, wherein
an adhesive force of the first holder is from 0.75 N/25 mm to 4.0 N/25 mm when at 20° C.

14. A holding member used in a processing device that performs processing on a target object by causing a processing tool to penetrate the target object, the holding member comprising:
a first holder configured by a urethane elastomer gel having self-adhesive properties, and configured to be able to hold the target object at a first surface of the first holder, the first holder having a plate shape; and
a second holder having a surface area larger than that of the first holder, and configured to hold the first holder by coming into contact with a second surface that is a surface on the opposite side from the first surface of the first holder, wherein
the first holder is removably held by the second holder,
the Asker C hardness of the first holder is from 20 to 40, and
an adhesive force of the first holder is from 0.5 N/25 mm to 6.0 N/25 mm when at 20° C.

15. A holding member used in a processing device that performs processing on a target object by causing a processing tool to penetrate the target object, the holding member comprising:
a first holder configured by a urethane elastomer gel having self-adhesive properties, and configured to be able to hold the target object at a first surface of the first holder, the first holder having a plate shape; and
a second holder having a surface area larger than that of the first holder, and configured to be adhered to a second surface that is a surface on the opposite side from the first surface of the first holder, wherein
the first holder is adhered to the second holder at a region excluding a peripheral edge portion of the second holder,
the Asker C hardness of the first holder is from 20 to 40,
an adhesive force of the first holder is from 0.5 N/25 mm to 6.0 N/25 mm when at 20° C., and
the second holder includes a mark, on the peripheral edge portion, indicating the holding member including the first holder.
